(19) United States
(12) Patent Application Publication
(10) Pub. No.: US 2024/0147427 A1
(43) Pub. Date: May 2, 2024

(54) PAGING OCCASION MONITORING

(71) Applicant: LENOVO (BEIJING) LIMITED, Beijing (CN)

(72) Inventors: Prateek Basu Mallick, Dreieich (DE); Joachim Löhr, Wiesbaden (DE); Lianhai Wu, Beijing (CN)

(21) Appl. No.: 18/548,713

(22) PCT Filed: Mar. 2, 2021
(86) PCT No.: PCT/CN2021/078662

§ 371 Date: Sep. 1, 2023

(51) Int. Cl. H04W 68/12

(52) U.S. Cl. CPC H04W 68/12; H04W 88/04

(57) ABSTRACT

Apparatuses, methods, and systems are disclosed for paging occasion monitoring. One method (700) includes determining (702), at a remote user equipment, at least one factor influencing an ability of the remote user equipment to monitor paging occasions that are for the remote user equipment, wherein the at least one factor comprises a radio condition, a battery usage, a configuration, a monitored parameter, or a combination thereof. The method (700) includes determining (704) whether the remote user equipment will monitor the paging occasions that are for the remote user equipment based on the factor influencing paging occasion monitoring. The method (700) includes, in response to determining that the remote user equipment will not monitor the paging occasions, transmitting (706) a request to a network device, a relay user equipment, or a combination thereof for the relay user equipment to monitor the paging occasions that are for the remote user equipment.

### FIELD

The subject matter disclosed herein relates generally to wireless communications and more particularly relates to paging occasion monitoring.

### BACKGROUND

In certain wireless communications networks, paging occasions may be monitored. In some configurations, it may be challenging to monitor paging occasions because of poor signal quality, configuration information, and/or performance data.

### BRIEF SUMMARY

Methods for paging occasion monitoring are disclosed. Apparatuses and systems also perform the functions of the methods. In one embodiment, the method includes determining, at a remote user equipment, at least one factor influencing an ability of the remote user equipment to monitor paging occasions that are for the remote user equipment, wherein the at least one factor comprises a radio condition, a battery usage, a configuration, a monitored parameter, or a combination thereof. In certain embodiments, the method includes determining whether the remote user equipment will monitor the paging occasions that are for the remote user equipment based on the factor influencing paging occasion monitoring. In various embodiments, the method includes, in response to determining that the remote user equipment will not monitor the paging occasions, transmitting a request to a network device, a relay user equipment, or a combination thereof for the relay user equipment to monitor the paging occasions that are for the remote user equipment.

An apparatus for paging occasion monitoring, in one embodiment, includes a remote user equipment. In some embodiments, the apparatus includes a processor that: determines at least one factor influencing an ability of the remote user equipment to monitor paging occasions that are for the remote user equipment, wherein the at least one factor comprises a radio condition, a battery usage, a configuration, a monitored parameter, or a combination thereof; and determines whether the remote user equipment will monitor the paging occasions that are for the remote user equipment based on the factor influencing paging occasion monitoring. In certain embodiments, the apparatus includes a transmitter that, in response to determining that the remote user equipment will not monitor the paging occasions, transmits a request to a network device, a relay user equipment, or a combination thereof for the relay user equipment to monitor the paging occasions that are for the remote user equipment.

In various embodiments, a method for paging occasion monitoring includes receiving a request at a relay user equipment to monitor paging occasions that are for a remote user equipment. In certain embodiments, the method includes determining whether the relay user equipment will monitor the paging occasions that are for the remote user equipment. In various embodiments, the method includes, in response to determining that the relay user equipment will monitor the paging occasions that are for the remote user equipment, transmitting information indicating that the relay user equipment will monitor the paging occasions that are for the remote user equipment.

An apparatus for paging occasion monitoring, in some embodiments, includes a relay user equipment. In some embodiments, the apparatus further includes a receiver that receives a request to monitor paging occasions that are for a remote user equipment. In various embodiments, the apparatus further includes a processor that determines whether the relay user equipment will monitor the paging occasions that are for the remote user equipment. In some embodiments, the apparatus includes a transmitter that in response to determining that the relay user equipment will monitor the paging occasions that are for the remote user equipment, transmits information indicating that the relay user equipment will monitor the paging occasions that are for the remote user equipment.

In some embodiments, a method for switching relay UEs includes identifying, at a network device, first information indicating a first serving cell identifier corresponding to a first relay user equipment. In certain embodiments, the method includes receiving second information indicating a second serving cell identifier corresponding to a second relay user equipment for a remote user equipment. In various embodiments, the method includes determining whether to switch the remote user equipment from the first relay user equipment to the second relay user equipment based on the first information and the second information.

An apparatus for switching relay UEs, in some embodiments, includes a network device. In some embodiments, the apparatus further includes a processor that identifies first information indicating a first serving cell identifier corresponding to a first relay user equipment. In various embodiments, the apparatus further includes a receiver that receives second information indicating a second serving cell identifier corresponding to a second relay user equipment for a remote user equipment. In certain embodiments, the processor determines whether to switch the remote user equipment from the first relay user equipment to the second relay user equipment based on the first information and the second information.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating one embodiment of a wireless communication system for paging occasion monitoring;

FIG. 2 is a schematic block diagram illustrating one embodiment of an apparatus that may be used for paging occasion monitoring;

FIG. 3 is a schematic block diagram illustrating another embodiment of an apparatus that may be used for paging occasion monitoring;

FIG. 4 is a communications diagram illustrating one embodiment of communications including a relay UE;

FIG. 5 is a communications diagram illustrating one embodiment of communications having paging occasion monitoring;

FIG. 6 is a communications diagram illustrating another embodiment of communications having paging occasion monitoring;

FIG. 7 is a schematic flow chart diagram illustrating one embodiment of a method for paging occasion monitoring;

FIG. 8 is a schematic flow chart diagram illustrating another embodiment of a method for paging occasion monitoring; and

FIG. 9 is a schematic flow chart diagram illustrating one embodiment of a method for switching relay UEs.

### DETAILED DESCRIPTION

As will be appreciated by one skilled in the art, aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code.

Certain of the functional units described in this specification may be labeled as modules, in order to more particularly emphasize their implementation independence. For example, a module may be implemented as a hardware circuit comprising custom very-large-scale integration (“VLSI”) circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in code and/or software for execution by various types of processors. An identified module of code may, for instance, include one or more physical or logical blocks of executable code which may, for instance, be organized as an object, procedure, or function. Nevertheless, the executables of an identified module need not be physically located together, but may include disparate instructions stored in different locations which, when joined logically together, include the module and achieve the stated purpose for the module.

Indeed, a module of code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Code for carrying out operations for embodiments may be any number of lines and may be written in any combination of one or more programming languages including an object oriented programming language such as Python, Ruby, Java, Smalltalk, C++, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”) or a wide area network (“WAN”), or the connection may be made to an external computer (for example, through the Internet using an Internet Service Provider).

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. The code may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams block or blocks.

The code may also be loaded onto a computer, other programmable data processing apparatus, or other devices to cause a series of operational steps to be performed on the computer, other programmable apparatus or other devices to produce a computer implemented process such that the code which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

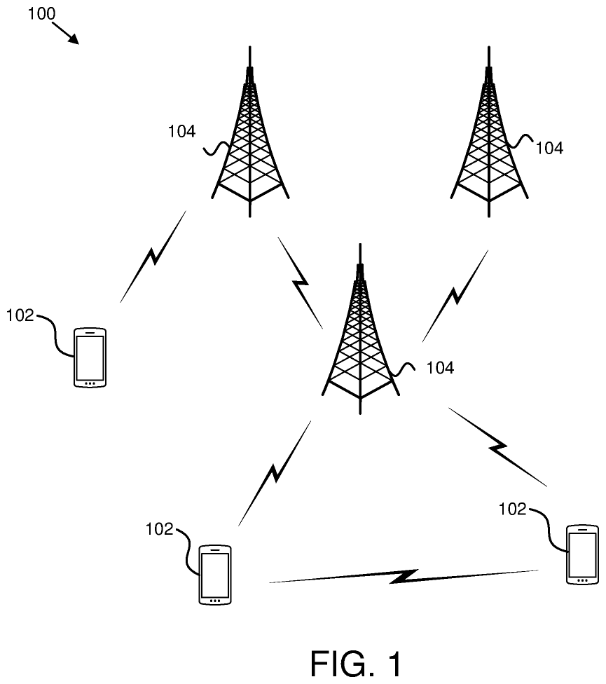

FIG. 1 depicts an embodiment of a wireless communication system 100 for paging occasion monitoring. In one embodiment, the wireless communication system 100 includes remote units 102 and network units 104. Even though a specific number of remote units 102 and network units 104 are depicted in FIG. 1, one of skill in the art will recognize that any number of remote units 102 and network units 104 may be included in the wireless communication system 100.

In one embodiment, the remote units 102 may include computing devices, such as desktop computers, laptop computers, personal digital assistants (“PDAs”), tablet computers, smart phones, smart televisions (e.g., televisions connected to the Internet), set-top boxes, game consoles, security systems (including security cameras), vehicle on-board computers, network devices (e.g., routers, switches, modems), IoT devices, or the like. In some embodiments, the remote units 102 include wearable devices, such as smart watches, fitness bands, optical head-mounted displays, or the like. Moreover, the remote units 102 may be referred to as subscriber units, mobiles, mobile stations, users, terminals, mobile terminals, fixed terminals, subscriber stations, user equipment (“UE”), user terminals, a device, or by other terminology used in the art. The remote units 102 may communicate directly with one or more of the network units 104 via uplink (“UL”) communication signals and/or the remote units 102 may communicate directly with other remote units 102 via sidelink communication.

The network units 104 may be distributed over a geographic region. In certain embodiments, a network unit 104 may also be referred to and/or may include one or more of an access point, an access terminal, a base, a base station, a Node-B, an evolved node-B (“eNB”), a 5G node-B (“gNB”), a Home Node-B, a relay node, a device, a core network, an aerial server, a radio access node, an access point (“AP”), new radio (“NR”), a network entity, an access and mobility management function (“AMF”), a unified data management (“UDM”), a unified data repository (“UDR”), a UDM/UDR, a policy control function (“PCF”), a radio access network (“RAN”), a network slice selection function (“NSSF”), an operations, administration, and management (“OAM”), a session management function (“SMF”), a user plane function (“UPF”), an application function, an authentication server function (“AUSF”), security anchor functionality (“SEAF”), trusted non-3GPP gateway function (“TNGF”), or by any other terminology used in the art. The network units 104 are generally part of a radio access network that includes one or more controllers communicably coupled to one or more corresponding network units 104. The radio access network is generally communicably coupled to one or more core networks, which may be coupled to other networks, like the Internet and public switched telephone networks, among other networks. These and other elements of radio access and core networks are not illustrated but are well known generally by those having ordinary skill in the art.

In one implementation, the wireless communication system 100 is compliant with NR protocols standardized in third generation partnership project (“3GPP”), wherein the network unit 104 transmits using an OFDM modulation scheme on the downlink (“DL”) and the remote units 102 transmit on the uplink (“UL”) using a single-carrier frequency division multiple access (“SC-FDMA”) scheme or an orthogonal frequency division multiplexing (“OFDM”) scheme. More generally, however, the wireless communication system 100 may implement some other open or proprietary communication protocol, for example, WiMAX, institute of electrical and electronics engineers (“IEEE”) 802.11 variants, global system for mobile communications (“GSM”), general packet radio service (“GPRS”), universal mobile telecommunications system (“UMTS”), long term evolution (“LTE”) variants, code division multiple access 2000 (“CDMA2000”), Bluetooth®, ZigBee, Sigfoxx, among other protocols. The present disclosure is not intended to be limited to the implementation of any particular wireless communication system architecture or protocol.

The network units 104 may serve a number of remote units 102 within a serving area, for example, a cell or a cell sector via a wireless communication link. The network units 104 transmit DL communication signals to serve the remote units 102 in the time, frequency, and/or spatial domain.

In various embodiments, a remote unit 102 (e.g., a remote user equipment) may determine at least one factor influencing an ability of the remote user equipment to monitor paging occasions that are for the remote user equipment, wherein the at least one factor comprises a radio condition, a battery usage, a configuration, a monitored parameter, or a combination thereof. In certain embodiments, the remote unit 102 may determine whether the remote user equipment will monitor the paging occasions that are for the remote user equipment based on the factor influencing paging occasion monitoring. In various embodiments, the remote unit 102 may, in response to determining that the remote user equipment will not monitor the paging occasions, transmit a request to a network device, a relay user equipment, or a combination thereof for the relay user equipment to monitor the paging occasions that are for the remote user equipment. Accordingly, a remote unit 102 may be used for paging occasion monitoring.

In certain embodiments, a remote unit 102 (e.g., a relay user equipment) may receive a request to monitor paging occasions that are for a remote user equipment. In certain embodiments, the remote unit 102 may determine whether the relay user equipment will monitor the paging occasions that are for the remote user equipment. In various embodiments, the remote unit 102 may, in response to determining that the relay user equipment will monitor the paging occasions that are for the remote user equipment, transmit information indicating that the relay user equipment will monitor the paging occasions that are for the remote user equipment. Accordingly, a remote unit 102 may be used for paging occasion monitoring.

In some embodiments, a network unit 104 may identify first information indicating a first serving cell identifier corresponding to a first relay user equipment. In certain embodiments, the network unit 104 may receive second information indicating a second serving cell identifier corresponding to a second relay user equipment for a remote user equipment. In various embodiments, the network unit 104 may determine whether to switch the remote user equipment from the first relay user equipment to the second relay user equipment based on the first information and the second information. Accordingly, a network unit 104 may be used for switching relay UEs.

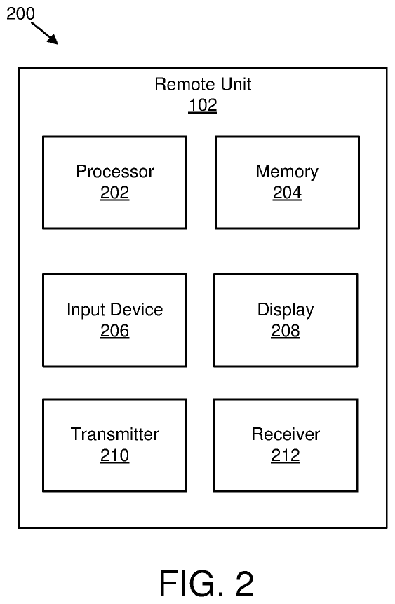

FIG. 2 depicts one embodiment of an apparatus 200 that may be used for paging occasion monitoring. The apparatus 200 includes one embodiment of the remote unit 102. Furthermore, the remote unit 102 may include a processor 202, a memory 204, an input device 206, a display 208, a transmitter 210, and a receiver 212. In some embodiments, the input device 206 and the display 208 are combined into a single device, such as a touchscreen. In certain embodiments, the remote unit 102 may not include any input device 206 and/or display 208. In various embodiments, the remote unit 102 may include one or more of the processor 202, the memory 204, the transmitter 210, and the receiver 212, and may not include the input device 206 and/or the display 208.

The processor 202, in one embodiment, may include any known controller capable of executing computer-readable instructions and/or capable of performing logical operations. For example, the processor 202 may be a microcontroller, a microprocessor, a central processing unit (“CPU”), a graphics processing unit (“GPU”), an auxiliary processing unit, a field programmable gate array (“FPGA”), or similar programmable controller. In some embodiments, the processor 202 executes instructions stored in the memory 204 to perform the methods and routines described herein. The processor 202 is communicatively coupled to the memory 204, the input device 206, the display 208, the transmitter 210, and the receiver 212.

The memory 204, in one embodiment, is a computer readable storage medium. In some embodiments, the memory 204 includes volatile computer storage media. For example, the memory 204 may include a RAM, including dynamic RAM (“DRAM”), synchronous dynamic RAM (“SDRAM”), and/or static RAM (“SRAM”). In some embodiments, the memory 204 includes non-volatile computer storage media. For example, the memory 204 may include a hard disk drive, a flash memory, or any other suitable non-volatile computer storage device. In some embodiments, the memory 204 includes both volatile and non-volatile computer storage media. In some embodiments, the memory 204 also stores program code and related data, such as an operating system or other controller algorithms operating on the remote unit 102.

The input device 206, in one embodiment, may include any known computer input device including a touch panel, a button, a keyboard, a stylus, a microphone, or the like. In some embodiments, the input device 206 may be integrated with the display 208, for example, as a touchscreen or similar touch-sensitive display. In some embodiments, the input device 206 includes a touchscreen such that text may be input using a virtual keyboard displayed on the touchscreen and/or by handwriting on the touchscreen. In some embodiments, the input device 206 includes two or more different devices, such as a keyboard and a touch panel.

The display 208, in one embodiment, may include any known electronically controllable display or display device. The display 208 may be designed to output visual, audible, and/or haptic signals. In some embodiments, the display 208 includes an electronic display capable of outputting visual data to a user. For example, the display 208 may include, but is not limited to, an liquid crystal display (“LCD”), an light emitting diode (“LED”) display, an organic light emitting diode (“OLED”) display, a projector, or similar display device capable of outputting images, text, or the like to a user. As another, non-limiting, example, the display 208 may include a wearable display such as a smart watch, smart glasses, a heads-up display, or the like. Further, the display 208 may be a component of a smart phone, a personal digital assistant, a television, a table computer, a notebook (laptop) computer, a personal computer, a vehicle dashboard, or the like.

In certain embodiments, the display 208 includes one or more speakers for producing sound. For example, the display 208 may produce an audible alert or notification (e.g., a beep or chime). In some embodiments, the display 208 includes one or more haptic devices for producing vibrations, motion, or other haptic feedback. In some embodiments, all or portions of the display 208 may be integrated with the input device 206. For example, the input device 206 and display 208 may form a touchscreen or similar touch-sensitive display. In other embodiments, the display 208 may be located near the input device 206.

In one embodiment, the processor 202: determines at least one factor influencing an ability of the remote user equipment to monitor paging occasions that are for the remote user equipment, wherein the at least one factor comprises a radio condition, a battery usage, a configuration, a monitored parameter, or a combination thereof; and determines whether the remote user equipment will monitor the paging occasions that are for the remote user equipment based on the factor influencing paging occasion monitoring. In certain embodiments, the transmitter 210, in response to determining that the remote user equipment will not monitor the paging occasions, transmits a request to a network device, a relay user equipment, or a combination thereof for the relay user equipment to monitor the paging occasions that are for the remote user equipment.

In various embodiments, the receiver 212 may receive a request to monitor paging occasions that are for a remote user equipment. In various embodiments, the processor 202 determines whether the relay user equipment will monitor the paging occasions that are for the remote user equipment. In some embodiments, the transmitter 210, in response to determining that the relay user equipment will monitor the paging occasions that are for the remote user equipment, transmits information indicating that the relay user equipment will monitor the paging occasions that are for the remote user equipment.

Although only one transmitter 210 and one receiver 212 are illustrated, the remote unit 102 may have any suitable number of transmitters 210 and receivers 212. The transmitter 210 and the receiver 212 may be any suitable type of transmitters and receivers. In one embodiment, the transmitter 210 and the receiver 212 may be part of a transceiver.

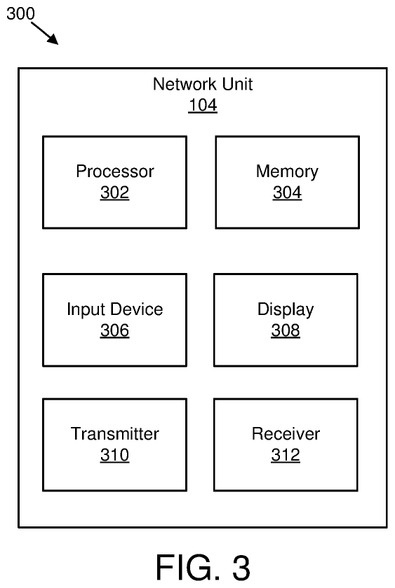

FIG. 3 depicts another embodiment of an apparatus 300 that may be used for paging occasion monitoring. The apparatus 300 includes one embodiment of the network unit 104. Furthermore, the network unit 104 may include a processor 302, a memory 304, an input device 306, a display 308, a transmitter 310, and a receiver 312. As may be appreciated, the processor 302, the memory 304, the input device 306, the display 308, the transmitter 310, and the receiver 312 may be substantially similar to the processor 202, the memory 204, the input device 206, the display 208, the transmitter 210, and the receiver 212 of the remote unit 102, respectively.

In certain embodiments, the processor 302 may identify first information indicating a first serving cell identifier corresponding to a first relay user equipment. In various embodiments, the receiver 312 may receive second information indicating a second serving cell identifier corresponding to a second relay user equipment for a remote user equipment. In certain embodiments, the processor 302 determines whether to switch the remote user equipment from the first relay user equipment to the second relay user equipment based on the first information and the second information.

Although only one transmitter 310 and one receiver 312 are illustrated, the network unit 104 may have any suitable number of transmitters 310 and receivers 312. The transmitter 310 and the receiver 312 may be any suitable type of transmitters and receivers. In one embodiment, the transmitter 310 and the receiver 312 may be part of a transceiver.

In some embodiments, there may be UE-to-network coverage extension. In such embodiments, Uu coverage reachability may be necessary for UEs to reach a server in a packet data network (“PDN”) or counterpart UE out of a proximity area.

In various embodiments, there may be a UE-to-UE coverage extension. In such embodiments, proximity reachability may be limited to a single-hop sidelink link, either via EUTRA-based technology or NR-based sidelink technology.

In certain embodiments, a UE-to-network coverage extension may be realized using a user to network (“U2N”) relay UE (hereinafter referred to as “U2N relay” or “relay”). In such embodiments, a remote UE may access a radio network in UL and/or DL using a U2N relay. In some embodiments, for an out of coverage remote UE, a U2N relay may be the only possibility for accessing a radio network but for some remote UEs in poor radio coverage, it may be more efficient to use a relay UE for accessing a radio network.

The UE may use discontinuous reception (“DRX”) in RRC_IDLE and RRC_INACTIVE states to reduce power consumption. The UE monitors one paging occasion (“PO”) per DRX cycle. A PO is a set of physical downlink control channel (“PDCCH”) monitoring occasions and may include multiple time slots (e.g., subframe or OFDM symbol) where paging DCI may be sent. One paging frame (“PF”) is one radio frame and may contain one or multiple PO(s) or starting point of a PO. In various embodiments, a relay UE may monitor paging occasions (“POs”) and/or PFs of a remote UE connected to it. This may reduce DL reception opportunities of a single receive (“RX”) capable relay and/or may consume excess power battery (e.g., if the remote UE has sufficiently good radio signals to receive its own paging).

In certain embodiments, a gNB may not have information about which remote UEs are connected to a Uu radio resource control (“RRC”) connected relay and, therefore, the gNB may not know paging occasions of the remote UEs. In such embodiments, the gNB may schedule the relay UE even if it is away monitoring paging on a different bandwidth part (“BWP”) (e.g., initial BWP) of an RRC idle and/or inactive remote UE.

In some embodiments, if there are multiple remote UEs connected to a RRC connected relay UE, the relay UE may need to monitor as many paging occasions for the remote UEs, but may also need to forward paging messages one by one to paged remote UEs. In such embodiments, the relay UE may consume excess relay battery power and may reduce DL reception opportunities.

In various embodiments, if a potential change of a U2N relay would lead to a change of a serving cell (e.g., for a remote UE as well), loss less relay reselection or mobility may not be possible to be ensured.

In certain embodiments, relay selection or reselections may be based on various criteria. In such embodiments, the criteria may include information about a cell (e.g., public land mobile network (“PLMN”), user agent client (“UAC”) parameters, etc.). In some embodiments, a UE may initiate a PC5-RRC connection and may determine it needs to release it after it receives system information. In various embodiments, system information (“SI”) may be needed for out of coverage (“OOC”) UEs or UEs in poor overlay network radio condition as part of relay selection. In such embodiments, it may be unknown when, how, and which system information needs to be provided for relay selection and/or reselection to facilitate a smooth transfer of the relay.

In some embodiments, RRC inactive UE RNTI (“I-RNTI”) may not be shared if considered sensitive on a PC5 link between a remote UE and relay UE (e.g., when using an L3 based U2N relay). In various embodiments, a RAN notification area update (“RNAU”) and/or a registration area update (“RAU”) of a remote UE may be inefficient.

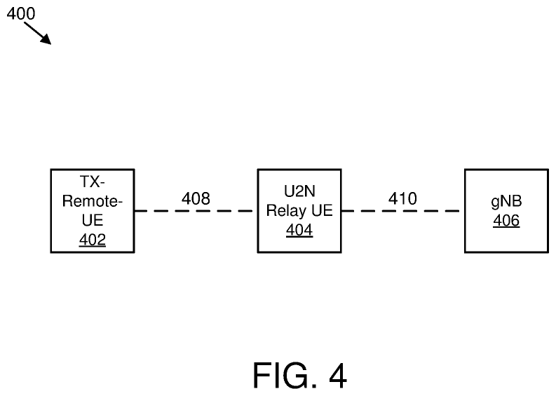

FIG. 4 is a communications diagram 400 illustrating one embodiment of communications including a relay UE. The communications diagram 400 includes a TX-Remote-UE 402 (UE1), a U2N relay UE 404 (UE2), and a gNB 406. The TX-Remote-UE 402 may communicate with the U2N relay UE 404 via a PC5 interface 408 and the U2N relay UE 404 may communicate with the gNB 406 via a Uu interface 410.

In some embodiments, the TX-Remote-UE 402 (UE1) is a UE that maintains an RRC state or mode (e.g., RRC connected, RRC idle, or RRC inactive) with the gNB 406 via the U2N relay UE 404 (UE2). Accordingly, in one embodiment, UE1 has one direct path (Uu) without using the relay UE2 and, in another embodiment, UE1 has one indirect path if using relay UE2. In certain embodiments, a direct path may be unavailable since UE1 may be out of coverage of the gNB 406 and/or have a too weak radio condition to support an efficient connection.

In various embodiments, a relay UE (e.g., U2N relay) or gNB may indicate to a remote UE if the relay UE is monitoring paging or can monitor paging for remote UEs or whether the remote UEs itself should monitor paging (e.g., if the relay is in an RRC connected mode and has only one RX). In some embodiments, a decision about whether a relay UE is to monitor paging occasions for remote UEs may be made by a gNB if a remote UE first establishes an RRC connection with the gNB, or if the relay UE informs the gNB about a new remote UE connecting to it on PC5. In certain embodiments, a decision about whether a relay UE is to monitor paging occasions for remote UEs may be made directly by the relay UE if a remote UE is first connected to the relay UE (e.g., PC5 RRC connection has been established). The decision by a gNB or by a UE relay (e.g., U2N relay) may be based on radio measurements from a remote UE. The radio measurements may indicate that a Uu radio interface for the remote UE is poor (e.g., below a certain network configured threshold) and/or a PC5 radio interface for the remote UE is good (e.g., above a certain network configured threshold).

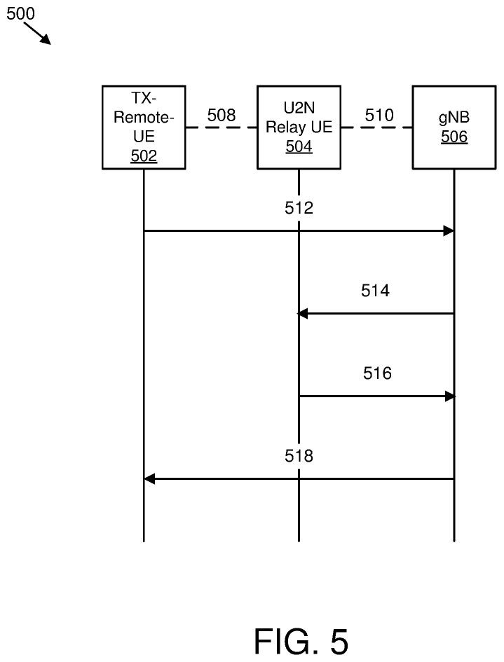

In some embodiments, a remote UE may decide (e.g., based on its radio condition and/or other factors like battery power) whether the remote UE needs assistance in monitoring its paging occasions. In such embodiments, the remote UE may request that the relay UE monitor its paging occasions if the remote UE is OOC or has a very poor Uu radio interface signal. The remote UE may request that the relay UE monitor its paging occasions using either a direct request to the relay UE or to the serving gNB as illustrated in FIG. 5.

FIG. 5 is a communications diagram illustrating one embodiment of communications 500 having paging occasion monitoring. The communications 500 include messages transmitted between a TX-Remote-UE 502, a U2N relay UE 504, and a gNB 506. Moreover, each of the communications 500 may include one or more messages. The TX-Remote-UE 502 may communicate with the U2N relay UE 504 via a PC5 interface 508 and the U2N relay UE 504 may communicate with the gNB 506 via a Uu interface 510.

In a first communication 512 transmitted from the TX-Remote-UE 502 to the gNB 506, the TX-Remote-UE 502 transmits relay assistance information (e.g., measurements, serving cell ID, information indicating whether paging monitoring is required and/or requested) to the gNB 506. In a second communication 514 transmitted from the gNB 506 to the U2N relay UE 504, the gNB 506 transmits a paging monitoring query to the U2N relay UE 504. In a third communication 516 transmitted from the U2N relay UE 504 to the gNB 506, the U2N relay UE 504 transmits a paging monitoring response to the gNB 506. In a fourth communication 518 transmitted from the gNB 506 to the TX-Remote-UE 502, the gNB 506 transmits an RRC reconfiguration message to the TX-Remote-UE 502.

In certain embodiments, the measurements provided by TX-Remote-UE 502 may be based on a measurement configuration provided by a network (e.g., the gNB 506). The measurement configuration may include thresholds for Uu and PC5 interface measurements.

In various embodiments found herein, a relay UE monitors paging occasions (e.g., POs and/or PFs) of a remote UE connected to it only if it is required to do so. In such embodiments, the relay UE monitoring paging occasions of the remote UE may avoid reducing DL reception opportunities of a single RX capable relay, may save power, and/or may reduce battery consumption.

In some embodiments, an RRC connected relay UE may inform the relay UE's serving gNB of information indicating at least one of: a) that the relay UE is monitoring a paging channel for one or more RRC idle and/or RRC inactive remote UEs; b) the paging occasions (or an equivalent away time, period, and/or pattern of all RRC idle and/or inactive remote UEs for which it is monitoring paging). The information may be updated by the relay UE whenever a new remote UE is added to a paging monitoring list or an existing remote UE is removed from the paging monitoring list. If the paging monitoring list is updated, the relay UE may autonomously switch its active DL BWP to an initial DL BWP. In certain embodiments, a network either does not schedule a relay UE during away periods or schedules the relay UE in an initial DL BWP. In various embodiments, instead of autonomous switching BWPs, a gNB switches an active BWP of a relay UE using explicit signaling to a DL BWP that is provided with at least one common search space (e.g., including pagingSearchSpace, searchSpaceSIB1 and searchSpaceOtherSystemInformation) on an active BWP to monitor paging.

In various embodiments, a gNB has information on which remote UEs are connected to a Uu RRC connected relay and may know paging occasions of the remote UEs. In such embodiments, the gNB may not schedule the relay UE if it is away monitoring paging on a different BWP (e.g., an initial BWP) of an RRC idle and/or RRC inactive remote UE.

In certain embodiments, a network may ensure that: a) a relay UE's current active DL BWP is provided with at least one of common search space (e.g., including pagingSearchSpace, searchSpaceSIB1 and searchSpaceOtherSystemInformation) on an active BWP to monitor paging b) paging for remote UEs connected to a given relay UE are sent on the relay UE's current active DL BWP instead of an initial DL BWP. This would enable the relay UE to stay on its current active BWP and receive paging for a remote UE, thus making BWP switches unnecessary.

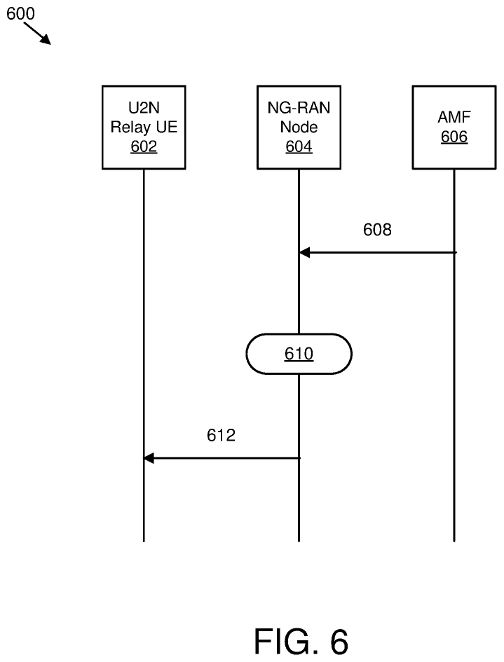

In some embodiments, a relay UE informs a gNB about which remote UEs are connected to it (e.g., 5G-S-TMSI). The relay UE receives the remote UE's 5G-S-TMSI from the relay UE. An NG-RAN Node (e.g., gNB) stores this association between the relay UE and the remote UE's 5G-S-TMSI. If a paging message for the remote UE is received from an AMF, as shown in FIG. 6, the paging message may be sent to the relay UE on the relay UE's paging occasions and on the current active DL BWP (e.g., either dedicatedly such as by using cell radio network temporary identifier (“RNTI”) (“C-RNTI”) or on a paging channel such as by using paging radio network temporary identifier (“P-RNTI”)—the latter obligates the relay UE to monitor a paging channel on its paging occasions while in any RRC state including RRC connected). In certain embodiments, if a gNB is to continue to use paging occasions of a remote UE to transmit any paging towards it, the gNB may inform the relay UE accordingly. This may obligate the relay UE to monitor a paging channel on the remote UE's paging occasions while in any RRC state including the RRC connected state.

In various embodiments, a remote UE requiring a relay UE to monitor its paging may establish an RRC connection and inform a network that it requires paging monitoring. A gNB and/or an AMF may remember an association between a remote UE's 5G-S-TMSI and the relay UE. If a core network (“CN”) and/or AMF implementation is used, then the AMF may remember the association between the 5G-S-TMSI of the relay UE and 5G-S-TMSIs of all remote UEs for which the relay UE is monitoring their paging. If any of the remote UEs are paged, the AMF includes the 5G-S-TMSI of the relay UE on an N2 interface (e.g., along with other information in a paging message), unless paging occasions of the remote UE should be used for paging it.

FIG. 6 is a communications diagram illustrating another embodiment of communications 600 having paging occasion monitoring. The communications 600 include messages transmitted between a U2N relay UE 602, an NG-RAN node 604, and an AMF 606. Moreover, each of the communications 600 may include one or more messages.

In a first communication 608 transmitted from the AMF 606 to the NG-RAN node 604, the AMF 606 may transmit paging (e.g., for a remote UE) to the NG-RAN node 604. The NG-RAN node 604 may determine 610 that the paging for the remote UE should be sent to the paging occasion of the U2N relay UE 602. In a second communication 612 transmitted from the NG-RAN node 604 to the U2N relay UE 602, the NG-RAN node 604 may transmit the paging for the remote UE to the U2N relay UE 602 (e.g., on the paging occasion of the U2N relay UE 602.

In certain embodiments, a paging delivery may be more efficient if a U2N relay is monitoring paging for many remote UEs connected to it. To achieve this, all remote UEs may be included in a group paging destination identifier (“ID”) (e.g., L2 group paging destination ID, special group destination IDs may be used for L1 and L2 filtering) and a received transport block may be forwarded via RRC signaling. A group for paging may be created by a relay UE or may be specified. Using a group paging destination ID, a relay UE may include paging records for multiple remote UEs in a combined manner. In some embodiments, a network may page all remote UEs connected to a relay UE in the same paging occasions (e.g., the same as that of the relay UE based on its identity). A benefit of some embodiments may be that a relay UE may send paging records for all paged remote UEs in one single transmission and/or message on PC5 and may save power. A benefit of various embodiments may be that a relay UE may need to monitor a limited number of POs on a Uu interface for one or more remote UEs.

In some embodiments, a serving cell may control mobility for an RRC connected remote UE. A U2N relay may advertise its serving cell ID and a remote UE may report a serving cell of a potential relay UE to its gNB (e.g., optionally including measurement results of a potential relay and/or a target frequency), in the serving cell to which the potential relay UE belongs. If the potential change of U2N relay may lead to a change of a remote UE's serving cell (e.g., since the potential relay UE is not being served by the serving cell of the remote UE), the gNB may: 1) configure measurements for a target cell and/or frequency of the serving cell of the potential relay—the UE may make measurement accordingly and sends a measurement report to the gNB; and/or 2) if a measurement report is available (e.g., including a frequency and/or cell ID), and the gNB may evaluate: a) whether to handover the remote UE to a target cell on a direct Uu link; and/or b) whether to handover the remote UE to the target cell on an indirect Uu link (e.g., with an X2 procedure indicating that post handover a particular relay U2N may be used (e.g., the Uu radio between the remote UE and the target cell is below a threshold and a direct link may not work or may be inefficient).

A benefit of some embodiments may be that a best decision between moving a UE to a target cell with a target relay UE (e.g., indirect Uu) or without using the target relay UE (e.g., direct Uu) may be made.

In certain embodiments, a gNB releases an RRC connection of a remote UE. In various embodiments, a remote UE releases a PC5 RRC connection with a source U2N relay and establishes a PC5 RRC connection with a target U2N relay UE if a Uu interface quality (e.g., between a remote UE and a target cell) is below a threshold and a direct link may not work or may be inefficient. In some embodiments, if a Uu interface quality with a target cell is above a certain network configured threshold, a remote UE may switch to a direct Uu interface connection on the target cell side (e.g., a potential relay UE and/or target relay UE is not used).

In various embodiments, there may be optimization of relay UE selection and/or reselection. In certain embodiments, idle and/or inactive remote UEs may bias a relay UE reselection to favor a relay UE that would avoid change of a RAN area or tracking area update (“TAU”) (e.g., select and/or reselect a target relay that is served by a serving cell that is part of the RAN area (e.g., using NotificationAreaInfo) and/or has the same tracking area code (“TAC”) that is already part of a remote UE's TA list). The biasing may be achieved using a radio parameter (e.g., measurement offset) to evaluate relay UE selection or reselections.

In some embodiments, information including at least one of an IE systemInformationAreaID and a bitmap indicating which SIBs or which features are supported by a relay UE's serving cell may be included in a discovery message transmitted from a relay UE. In such embodiments, based on the information, a potential remote UE may determine whether a relay UE is suitable such as if the relay UE is being served by a cell that supports features and/or functionalities (e.g., vehicle to everything (“V2X”), mobile broadband services (“MBS”), positioning methods, etc.) of interest to the remote UE. In such embodiments, a valueTag of individual SIBs may be advertised in the discovery message or in a subsequent message by the relay UE.

In various embodiments, a discovery message may contain only a few (e.g., 1) PLMN (e.g., a first PLMN ID appearing in an SIB1 of a cell). In such embodiments, the rest of the PLMNs may be included in another message (e.g., as a separate groupcast by a relay UE). In certain embodiments, a systemInformationAreaID may apply to a PLMN list.

In certain embodiments, a relay UE sends information including a PLMN-IdentityInfoList and/or SI-scheduling-info after every cell reselection or handover to a PC5 connected remote UE. The remote UE may use this information to evaluate a situation and/or trigger, when necessary, the remote UE's RNAU and/or RAU procedure using a U2N relay just for relaying purpose. In some embodiments, information elements (“IEs”) RAN-NotificationAreaInfo/TA and PeriodicRNAU-TimerValue may be shared by a remote UE with a serving U2N relay UE. In such embodiments, the relay UE may evaluate a RNAU update and/or RAU necessity after each cell reselection and handover for each of connected remote UE and may initiate a corresponding procedure itself on behalf of the remote UE or may signal for the remote UE to do so.

In various embodiments, to alleviate security concerns in sharing I-RNTI of a remote UE with a relay UE: 1) a gNB may share the I-RNTI of a remote UE with a relay UE while releasing a corresponding remote UE to an RRC inactive mode—this may be done by including the I-RNTI within the RRC message transmitted towards the relay UE including an RRC release message of the remote UE or by signaling the I-RNTI of the remote UE separately to the relay UE; and/or 2) use a local UE identity for a remote UE. The local UE identity may be a unique in a gNB and/or cell. A serving gNB may use the local UE identity to page an RRC inactive remote UE. The relay UE may maintain a list of local UE identities (e.g., all remote UEs connected to it). If a remote UE connects to a relay UE belonging to a new cell, the relay UE may need to obtain the local UE identity for the remote UE.

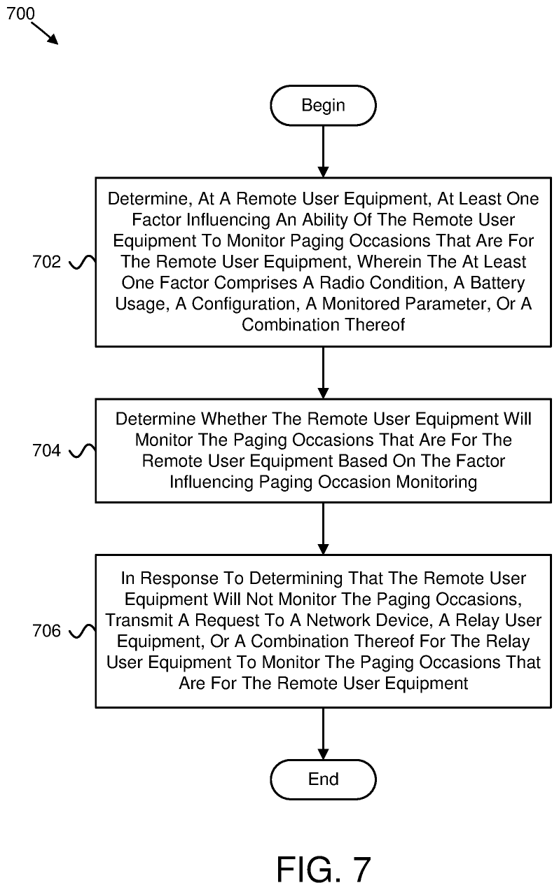

FIG. 7 is a schematic flow chart diagram illustrating one embodiment of a method 700 for paging occasion monitoring. In some embodiments, the method 700 is performed by an apparatus, such as the remote unit 102. In certain embodiments, the method 700 may be performed by a processor executing program code, for example, a microcontroller, a microprocessor, a CPU, a GPU, an auxiliary processing unit, a FPGA, or the like.

The method 700 may include determining 702, at a remote user equipment, at least one factor influencing an ability of the remote user equipment to monitor paging occasions that are for the remote user equipment, wherein the at least one factor comprises a radio condition, a battery usage, a configuration, a monitored parameter, or a combination thereof. In certain embodiments, the method 700 includes determining 704 whether the remote user equipment will monitor the paging occasions that are for the remote user equipment based on the factor influencing paging occasion monitoring. In various embodiments, the method 700 includes, in response to determining that the remote user equipment will not monitor the paging occasions, transmitting 706 a request to a network device, a relay user equipment, or a combination thereof for the relay user equipment to monitor the paging occasions that are for the remote user equipment.

In certain embodiments, the remote user equipment has a PC5 radio resource control connection with the relay user equipment. In some embodiments, the radio condition is with respect to at least one of an overlay radio access network and a user equipment to network relay.

In various embodiments, the radio condition comprises a measurement performed based on a configuration provided by the network device and relayed by a user equipment to network relay. In one embodiment, transmitting the request to the network device, the relay user equipment, or the combination thereof for the relay user equipment to monitor the paging occasions that are for the remote user equipment comprises transmitting information indicating the at least one factor with the request.

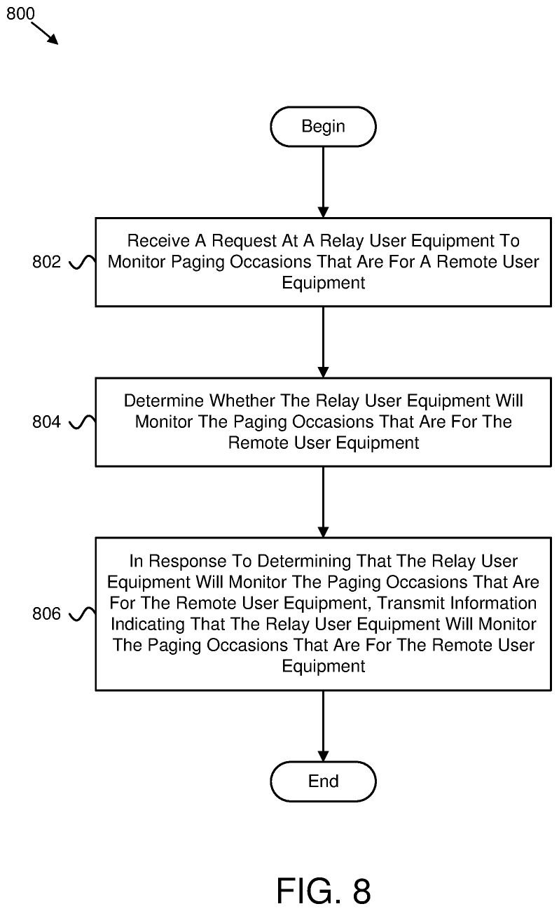

FIG. 8 is a schematic flow chart diagram illustrating another embodiment of a method 800 for paging occasion monitoring. In some embodiments, the method 800 is performed by an apparatus, such as the remote unit 102. In certain embodiments, the method 800 may be performed by a processor executing program code, for example, a microcontroller, a microprocessor, a CPU, a GPU, an auxiliary processing unit, a FPGA, or the like.

The method 800 may include receiving 802 a request at a relay user equipment to monitor paging occasions that are for a remote user equipment. In certain embodiments, the method 800 includes determining 804 whether the relay user equipment will monitor the paging occasions that are for the remote user equipment. In various embodiments, the method 800 includes, in response to determining that the relay user equipment will monitor the paging occasions that are for the remote user equipment, transmitting 806 information indicating that the relay user equipment will monitor the paging occasions that are for the remote user equipment.

In certain embodiments, receiving the request at the relay user equipment to monitor paging occasions that are for the remote user equipment comprises receiving the request from the remote user equipment, a network device, or a combination thereof. In some embodiments, determining whether the relay user equipment will monitor the paging occasions that are for the remote user equipment comprises determining whether the relay user equipment will monitor the paging occasions that are for the remote user equipment based on whether the relay user equipment has at least two receiver chains. In various embodiments, a network device determines whether to transmit the request for the relay user equipment to monitor the paging occasions that are for the remote user equipment based on at least one factor.

In one embodiment, the at least one factor comprises a radio condition of the remote user equipment, a battery usage of the remote user equipment, a configuration of the remote user equipment, a monitored parameter of the remote user equipment, or a combination thereof. In certain embodiments, the method 800 further comprises transmitting information from the relay user equipment to a network device indicating: a monitoring paging channel for the remote user equipment, a set of paging occasions that the relay user equipment is monitoring, or a combination thereof. In some embodiments, the method 800 further comprises switching from an active downlink bandwidth part to an initial bandwidth part to monitor the paging occasions that are for the remote user equipment.

In various embodiments, the method 800 further comprises receiving information from a network device indicating for the relay user equipment to switch to a different bandwidth part to monitor the paging occasions that are for the remote user equipment. In one embodiment, the paging occasions correspond to a plurality of remote user equipments. In certain embodiments, the plurality of remote user equipments are identified using a group paging destination layer 2 identifier.

In some embodiments, the method 800 further comprises reporting information corresponding to the paging occasions for the plurality of relay user equipments using the group paging destination layer 2 identifier.

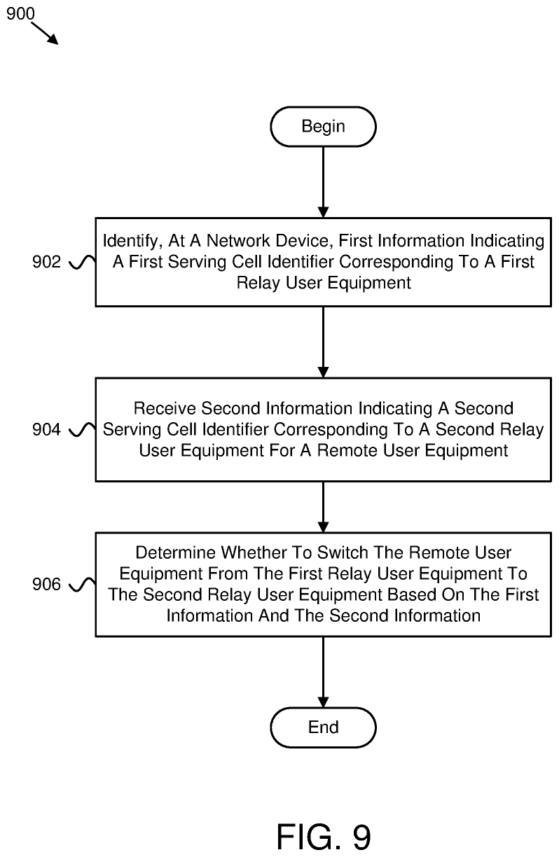

FIG. 9 is a schematic flow chart diagram illustrating one embodiment of a method 900 for switching relay UEs. In some embodiments, the method 900 is performed by an apparatus, such as the network unit 104. In certain embodiments, the method 900 may be performed by a processor executing program code, for example, a microcontroller, a microprocessor, a CPU, a GPU, an auxiliary processing unit, a FPGA, or the like.

The method 900 may include identifying 902, at a network device, first information indicating a first serving cell identifier corresponding to a first relay user equipment. In certain embodiments, the method 900 includes receiving 904 second information indicating a second serving cell identifier corresponding to a second relay user equipment for a remote user equipment. In various embodiments, the method 900 includes determining 906 whether to switch the remote user equipment from the first relay user equipment to the second relay user equipment based on the first information and the second information.

In certain embodiments, the method 900 further comprises receiving, from the remote user equipment, third information comprising measurement results corresponding to the second relay user equipment, a target frequency corresponding to the second relay user equipment, or a combination thereof. In some embodiments, the method 900 further comprises, in response to the first serving cell identifier being different from the second serving cell identifier, transmitting measurement configuration information to the remote user equipment if third information comprising measurement results is not available at the network device. In various embodiments, the measurement configuration information comprises information indicating to perform measurements on a second serving cell corresponding to the second serving cell identifier, a frequency corresponding to the second serving cell, or a combination thereof.

In one embodiment, the method 900 further comprises receiving a measurement report from the remote user equipment, wherein the measurement report corresponds to the measurement configuration information. In certain embodiments, the method 900 further comprises determining whether handover of the remote user equipment to the second serving cell is to be on a direct Uu link or an indirect Uu link based on the measurement report. In some embodiments, the method 900 further comprises, in response to determining to switch the remote user equipment from the first relay user equipment to the second relay user equipment, releasing a radio resource control connection of the remote user equipment.

In various embodiments, the remote unit receives, from the relay user equipment, third information comprising in information element systemInformationAreaID, a bitmap indicating which system information blocks are supported by the second serving cell, or a combination thereof, and evaluates suitability of the relay user equipment based on the third information.

In one embodiment, a method comprises: determining, at a remote user equipment, at least one factor influencing an ability of the remote user equipment to monitor paging occasions that are for the remote user equipment, wherein the at least one factor comprises a radio condition, a battery usage, a configuration, a monitored parameter, or a combination thereof; determining whether the remote user equipment will monitor the paging occasions that are for the remote user equipment based on the factor influencing paging occasion monitoring; and, in response to determining that the remote user equipment will not monitor the paging occasions, transmitting a request to a network device, a relay user equipment, or a combination thereof for the relay user equipment to monitor the paging occasions that are for the remote user equipment.

In certain embodiments, the remote user equipment has a PC5 radio resource control connection with the relay user equipment.

In some embodiments, the radio condition is with respect to at least one of an overlay radio access network and a user equipment to network relay.

In various embodiments, the radio condition comprises a measurement performed based on a configuration provided by the network device and relayed by a user equipment to network relay.

In one embodiment, transmitting the request to the network device, the relay user equipment, or the combination thereof for the relay user equipment to monitor the paging occasions that are for the remote user equipment comprises transmitting information indicating the at least one factor with the request.

In one embodiment, an apparatus comprises a remote user equipment. The apparatus further comprises: a processor that: determines at least one factor influencing an ability of the remote user equipment to monitor paging occasions that are for the remote user equipment, wherein the at least one factor comprises a radio condition, a battery usage, a configuration, a monitored parameter, or a combination thereof; and determines whether the remote user equipment will monitor the paging occasions that are for the remote user equipment based on the factor influencing paging occasion monitoring; and a transmitter that, in response to determining that the remote user equipment will not monitor the paging occasions, transmits a request to a network device, a relay user equipment, or a combination thereof for the relay user equipment to monitor the paging occasions that are for the remote user equipment.

In certain embodiments, the remote user equipment has a PC5 radio resource control connection with the relay user equipment.

In some embodiments, the radio condition is with respect to at least one of an overlay radio access network and a user equipment to network relay.

In various embodiments, the radio condition comprises a measurement performed based on a configuration provided by the network device and relayed by a user equipment to network relay.

In one embodiment, the transmitter transmitting the request to the network device, the relay user equipment, or the combination thereof for the relay user equipment to monitor the paging occasions that are for the remote user equipment comprises the transmitter transmitting information indicating the at least one factor with the request.

In one embodiment, a method comprises: receiving a request at a relay user equipment to monitor paging occasions that are for a remote user equipment; determining whether the relay user equipment will monitor the paging occasions that are for the remote user equipment; and in response to determining that the relay user equipment will monitor the paging occasions that are for the remote user equipment, transmitting information indicating that the relay user equipment will monitor the paging occasions that are for the remote user equipment.

In certain embodiments, receiving the request at the relay user equipment to monitor paging occasions that are for the remote user equipment comprises receiving the request from the remote user equipment, a network device, or a combination thereof.

In some embodiments, determining whether the relay user equipment will monitor the paging occasions that are for the remote user equipment comprises determining whether the relay user equipment will monitor the paging occasions that are for the remote user equipment based on whether the relay user equipment has at least two receiver chains.

In various embodiments, a network device determines whether to transmit the request for the relay user equipment to monitor the paging occasions that are for the remote user equipment based on at least one factor.

In one embodiment, the at least one factor comprises a radio condition of the remote user equipment, a battery usage of the remote user equipment, a configuration of the remote user equipment, a monitored parameter of the remote user equipment, or a combination thereof.

In certain embodiments, the method further comprises transmitting information from the relay user equipment to a network device indicating: a monitoring paging channel for the remote user equipment, a set of paging occasions that the relay user equipment is monitoring, or a combination thereof.

In some embodiments, the method further comprises switching from an active downlink bandwidth part to an initial bandwidth part to monitor the paging occasions that are for the remote user equipment.

In various embodiments, the method further comprises receiving information from a network device indicating for the relay user equipment to switch to a different bandwidth part to monitor the paging occasions that are for the remote user equipment.

In one embodiment, the paging occasions correspond to a plurality of remote user equipments.

In certain embodiments, the plurality of remote user equipments are identified using a group paging destination layer 2 identifier.

In some embodiments, the method further comprises reporting information corresponding to the paging occasions for the plurality of relay user equipments using the group paging destination layer 2 identifier.

In one embodiment, an apparatus comprises a relay user equipment. The apparatus further comprises: a receiver that receives a request to monitor paging occasions that are for a remote user equipment; a processor that determines whether the relay user equipment will monitor the paging occasions that are for the remote user equipment; and a transmitter that in response to determining that the relay user equipment will monitor the paging occasions that are for the remote user equipment, transmits information indicating that the relay user equipment will monitor the paging occasions that are for the remote user equipment.

In certain embodiments, the receiver receiving the request to monitor paging occasions that are for the remote user equipment comprises the receiver receiving the request from the remote user equipment, a network device, or a combination thereof.

In some embodiments, the processor determining whether the relay user equipment will monitor the paging occasions that are for the remote user equipment comprises the processor determining whether the relay user equipment will monitor the paging occasions that are for the remote user equipment based on whether the relay user equipment has at least two receiver chains.

In various embodiments, a network device determines whether to transmit the request for the relay user equipment to monitor the paging occasions that are for the remote user equipment based on at least one factor.

In one embodiment, the at least one factor comprises a radio condition of the remote user equipment, a battery usage of the remote user equipment, a configuration of the remote user equipment, a monitored parameter of the remote user equipment, or a combination thereof.

In certain embodiments, the transmitter transmits information from the relay user equipment to a network device indicating: a monitoring paging channel for the remote user equipment, a set of paging occasions that the relay user equipment is monitoring, or a combination thereof.

In some embodiments, the processor switches from an active downlink bandwidth part to an initial bandwidth part to monitor the paging occasions that are for the remote user equipment.

In various embodiments, the receiver receives information from a network device indicating for the relay user equipment to switch to a different bandwidth part to monitor the paging occasions that are for the remote user equipment.

In one embodiment, the paging occasions correspond to a plurality of remote user equipments.

In certain embodiments, the plurality of remote user equipments are identified using a group paging destination layer 2 identifier.

In some embodiments, the transmitter reports information corresponding to the paging occasions for the plurality of relay user equipments using the group paging destination layer 2 identifier.

In one embodiment, a method comprises: identifying, at a network device, first information indicating a first serving cell identifier corresponding to a first relay user equipment; receiving second information indicating a second serving cell identifier corresponding to a second relay user equipment for a remote user equipment; and determining whether to switch the remote user equipment from the first relay user equipment to the second relay user equipment based on the first information and the second information.

In certain embodiments, the method further comprises receiving, from the remote user equipment, third information comprising measurement results corresponding to the second relay user equipment, a target frequency corresponding to the second relay user equipment, or a combination thereof.

In some embodiments, the method further comprises, in response to the first serving cell identifier being different from the second serving cell identifier, transmitting measurement configuration information to the remote user equipment if third information comprising measurement results is not available at the network device.

In various embodiments, the measurement configuration information comprises information indicating to perform measurements on a second serving cell corresponding to the second serving cell identifier, a frequency corresponding to the second serving cell, or a combination thereof.

In one embodiment, the method further comprises receiving a measurement report from the remote user equipment, wherein the measurement report corresponds to the measurement configuration information.

In certain embodiments, the method further comprises determining whether handover of the remote user equipment to the second serving cell is to be on a direct Uu link or an indirect Uu link based on the measurement report.

In some embodiments, the method further comprises, in response to determining to switch the remote user equipment from the first relay user equipment to the second relay user equipment, releasing a radio resource control connection of the remote user equipment.

In various embodiments, the remote unit receives, from the relay user equipment, third information comprising in information element systemInformationAreaID, a bitmap indicating which system information blocks are supported by the second serving cell, or a combination thereof, and evaluates suitability of the relay user equipment based on the third information.

In one embodiment, an apparatus comprises a network device. The apparatus further comprises: a processor that identifies first information indicating a first serving cell identifier corresponding to a first relay user equipment; and a receiver that receives second information indicating a second serving cell identifier corresponding to a second relay user equipment for a remote user equipment; wherein the processor determines whether to switch the remote user equipment from the first relay user equipment to the second relay user equipment based on the first information and the second information.

In certain embodiments, the receiver receives, from the remote user equipment, third information comprising measurement results corresponding to the second relay user equipment, a target frequency corresponding to the second relay user equipment, or a combination thereof.

In some embodiments, the method further comprises a transmitter that, in response to the first serving cell identifier being different from the second serving cell identifier, transmits measurement configuration information to the remote user equipment if third information comprising measurement results is not available at the network device.

In various embodiments, the measurement configuration information comprises information indicating to perform measurements on a second serving cell corresponding to the second serving cell identifier, a frequency corresponding to the second serving cell, or a combination thereof.

In one embodiment, the receiver receives a measurement report from the remote user equipment, and the measurement report corresponds to the measurement configuration information.

In certain embodiments, the processor determines whether handover of the remote user equipment to the second serving cell is to be on a direct Uu link or an indirect Uu link based on the measurement report.

In some embodiments, in response to the processor determining to switch the remote user equipment from the first relay user equipment to the second relay user equipment, the processor releases a radio resource control connection of the remote user equipment.

In various embodiments, the remote unit receives, from the relay user equipment, third information comprising in information element systemInformationAreaID, a bitmap indicating which system information blocks are supported by the second serving cell, or a combination thereof, and evaluates suitability of the relay user equipment based on the third information.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A processor for wireless communication, comprising:
at least one controller coupled with at least one memory and configured to cause the processor to:
determine, at a remote user equipment (UE), at least one factor influencing an ability of the remote UE to monitor paging occasions that are for the remote UE, wherein the at least one factor comprises a radio condition, a battery usage, a configuration, a monitored parameter, or a combination thereof;
determine whether the remote UE will monitor the paging occasions that are for the remote UE based on the at least one factor influencing the paging occasion monitoring; and
in response to determining that the remote UE will not monitor the paging occasions, transmit a request to a network device, a relay UE, or a combination thereof for the relay UE to monitor the paging occasions that are for the remote UE.

2. The processor of claim 1, wherein the remote UE has a PC5 radio resource control (RRC) connection with the relay UE.

3. The processor of claim 1, wherein the radio condition is with respect to at least one of an overlay radio access network and a UE to network relay.

4. The processor of claim 1, wherein the radio condition comprises a measurement performed based on a configuration provided by the network device and relayed by a UE to network relay.

5. The processor of claim 1, the at least one controller is configured to cause the processor to transmit the request to the network device, the relay UE, or the combination thereof for the relay UE to monitor the paging occasions that are for the remote UE by transmitting information indicating the at least one factor with the request.

6. A remote user equipment (UE), comprising:
at least one memory; and
at least one processor coupled with the at least one memory and configured to cause the remote UE to:
determine at least one factor influencing an ability of the remote UE to monitor paging occasions that are for the remote UE, wherein the at least one factor comprises a radio condition, a battery usage, a configuration, a monitored parameter, or a combination thereof; and
determine whether the remote UE will monitor the paging occasions that are for the remote UE based on the at least one factor influencing the paging occasion monitoring; and
in response to determining that the remote UE will not monitor the paging occasions, transmit a request to a network device, a relay UE, or a combination thereof for the relay UE to monitor the paging occasions that are for the remote UE.

7. The remote UE of claim 6, wherein the radio condition comprises a measurement performed based on a configuration provided by the network device and relayed by a UE to network relay.

8. The remote UE of claim 6, wherein the at least one processor is configured to cause the remote UE to transmit the request to the network device, the relay UE, or the combination thereof for the relay UE to monitor the paging occasions that are for the remote UE by transmitting information indicating the at least one factor with the request.

9. A processor for wireless communication, comprising:
at least one controller coupled with at least one memory and configured to cause the processor to:
receive a request at a relay user equipment (UE) to monitor paging occasions that are for a remote UE;
determine whether the relay UE will monitor the paging occasions that are for the remote UE; and
in response to determining that the relay UE will monitor the paging occasions that are for the remote UE, transmit information indicating that the relay UE will monitor the paging occasions that are for the remote UE.

10. The processor of claim 9, wherein the at least one controller is configured to cause the processor to receive the request at the relay UE to monitor paging occasions that are for the remote UE by receiving the request from the remote UE, a network device, or a combination thereof.

11. The processor of claim 9, wherein the at least one controller is configured to cause the processor to determine whether the relay UE will monitor the paging occasions that are for the remote UE by determining whether the relay UE will monitor the paging occasions that are for the remote UE based on whether the relay UE has at least two receiver chains.

12. The processor of claim 9, wherein a network device determines whether to transmit the request for the relay UE to monitor the paging occasions that are for the remote UE based on at least one factor.

13. The processor of claim 12, wherein the at least one factor comprises a radio condition of the remote UE, a battery usage of the remote UE, a configuration of the remote UE, a monitored parameter of the remote UE, or a combination thereof.

14. The processor of claim 9, wherein the at least one controller is configured to cause the processor to transmit information from the relay UE to a network device indicating: a monitoring paging channel for the remote UE, a set of paging occasions that the relay UE is monitoring, or a combination thereof.

15. The processor of claim 9, wherein the at least one controller is configured to cause the processor to switch from an active downlink bandwidth part to an initial bandwidth part to monitor the paging occasions that are for the remote UE.

16. The processor of claim 9, wherein the at least one controller is configured to cause the processor to receive information from a network device indicating for the relay UE to switch to a different bandwidth part to monitor the paging occasions that are for the remote UE.

17. The processor of claim 9, wherein the paging occasions correspond to a plurality of remote UEs.

18. The processor of claim 17, wherein the plurality of remote UEs are identified using a group paging destination layer 2 identifier.

19. The processor of claim 18, wherein the at least one controller is configured to cause the processor to report information corresponding to the paging occasions for the plurality of remote UEs using the group paging destination layer 2 identifier.

20. A relay user equipment (UE), comprising:
at least one memory; and
at least one processor coupled with the at least one memory and configured to cause the relay UE to:
receive a request to monitor paging occasions that are for a remote UE;
determine whether the relay UE will monitor the paging occasions that are for the remote UE; and
in response to determining that the relay UE will monitor the paging occasions that are for the remote UE, transmit information indicating that the relay UE will monitor the paging occasions that are for the remote UE.
